(19) United States
(12) Patent Application Publication
(10) Pub. No.: US 2025/0354078 A1
(43) Pub. Date: Nov. 20, 2025

(54) OXIDATION RESISTANCE OF LUBRICANT WITH MODIFIED EPOXIDE-BASED LINKAGES

(71) Applicant: Western Digital Technologies, Inc., San Jose, CA (US)

(72) Inventors: Hantao Zhou, San Jose, CA (US); Daniel Demori Maksuta, San Jose, CA (US); Ao Fan, Shenzhen (CN); Jianming Wen, Pleasanton, CA (US); Charles Cheng-Hsing Lee, San Jose, CA (US)

(21) Appl. No.: 18/666,635

(22) Filed: May 16, 2024

(51) Int. Cl. C10M 107/38; C08G 65/331; C10N 40/18; G11B 5/00; G11B 5/725

(52) U.S. Cl. CPC C10M 107/38; C08G 65/331; G11B 5/7257; C10M 2213/0606; C10N 2040/18; G11B 2005/0021

(57) ABSTRACT

Lubricants with epoxide-based linkages for Heat Assisted Magnetic Recording (HAMR) are provided. Epoxide chemistry produces one such lubricant for magnetic media according to general formula (Ia):

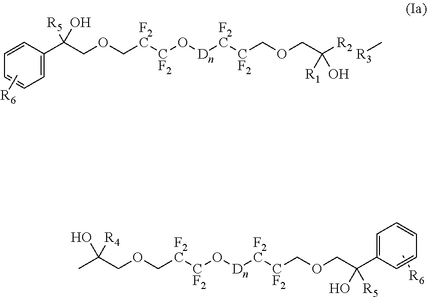

where Dₙ is —(CF₂CF₂CF₂O)ₙ—, R₁, R₂, R₃, R₄, R₅ and R₆ independently comprise single or branched non-fluorinated or fluorinated C₁-C₁₀ alkyl, C₁-C₁₀ alkoxy, benzene, naphthalene, anthracene, phenanthrene, dibenz[a,h]anthracene, pyrene or benzopyrene, with n being from 2 to 50.

### FIELD

The disclosure relates to lubricants, and more particularly, to high temperature lubricants, which may be used with media configured for magnetic recording, e.g., for Heat Assisted Magnetic Recording (HAMR) or other hard disk drive (HDD) media that incorporate modified epoxy-based linkages.

### INTRODUCTION

Magnetic storage systems, such as a hard disk drive (HDD), are utilized in a wide variety of devices in both stationary and mobile computing environments. Examples of devices that incorporate magnetic storage systems include data center storage systems, desktop computers, portable notebook computers, portable hard disk drives, network storage systems, high definition television (HDTV) receivers, vehicle control systems, cellular or mobile telephones, television set top boxes, digital cameras, digital video cameras, video game consoles, and portable media players.

A typical disk drive includes magnetic storage media in the form of one or more flat disks or platters. The disks generally include two main components, namely, a substrate material that gives it structure and rigidity, and a magnetic media coating that stores the magnetic signals that represent data in a recording layer within the coating. The typical disk drive also includes a read head and a write head, generally in the form of a magnetic transducer which can sense and/or change the magnetic fields stored on the recording layer of the disks. HAMR, MAMR, PMR, ePMR and SMR are recording techniques that can increase the areal density capability (ADC) of written data on a magnetic storage medium having very high coercivity with high-temperature assistance. However, the high recording temperatures applied to the media may present challenges. Other examples of magnetic storage media include flexible tape media usable for magnetic tape recording.

As a result of the high temperatures associated with HAMR technology, suitable lubricants for use in HAMR or other HDD media may benefit from high thermal stability. As such, there is a need in the art for high temperature lubricants (e.g., lubricants capable of withstanding high temperatures) having properties suitable for use in HDDs, including the ability to sequester and/or remove contaminants prior to the contaminants interfering with data storage or other operational processes. That is, the oxidation resistance of the lubricant of the lubricant will have the stability for a more durable tribochemical interface.

### SUMMARY

In one aspect, this disclosure provides an epoxide based lubricant according to one of general formulas (Ia) to (Id):

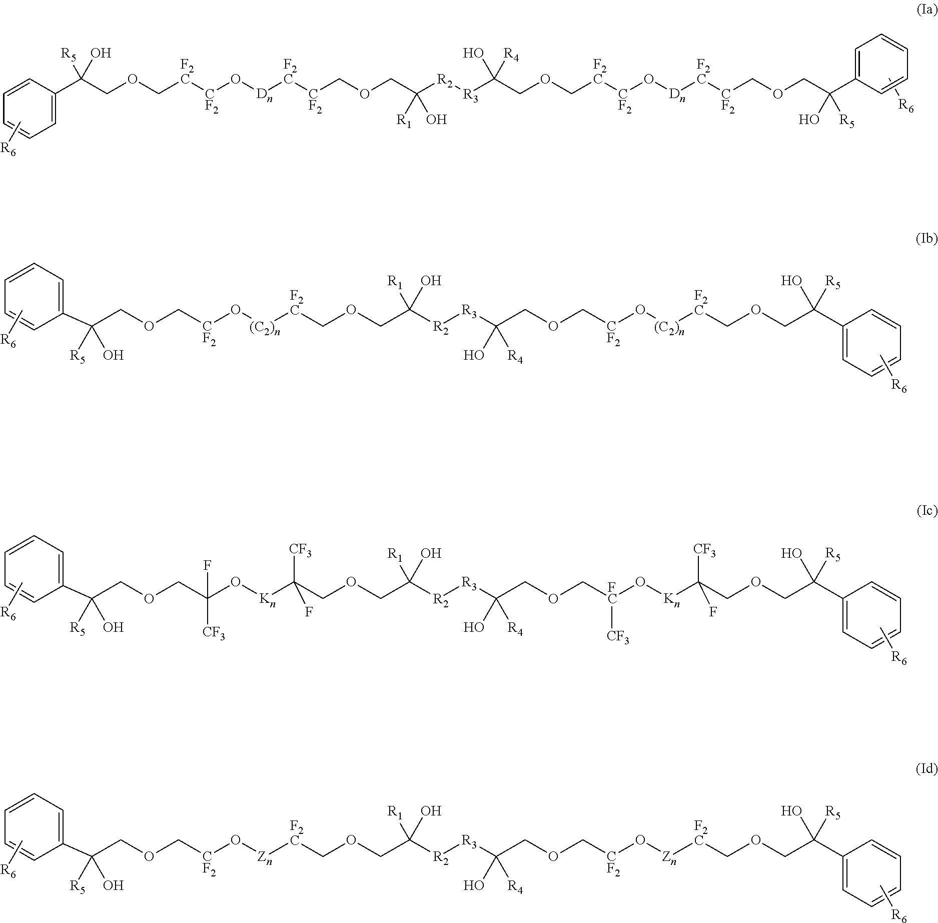

where D₁ is —(CF₂CF₂CF₂O)ₙ—,
(C₂)₁ is —(CF₂CF₂O)ₙ—,
Kₙ is —(CF₂CF(CF₃)O)ₙ—,
Zₙ is —(CF₂CF₂O)ₓ(CF₂O)_{y},
R₁, R₂, R₃, R₄, R₅ and R₆ independently comprise single or branched non-fluorinated or fluorinated C₁-C₁₀ alkyl, C₁-C₁₀ alkoxy, benzene, naphthalene, anthracene, phenanthrene, dibenz[a,h]anthracene, pyrene or benzopyrene, with n, x and y each independently being from 2 to 50.

In one aspect, the lubricant described above wherein R₁, R₂, R₃, R₄, R₅ and R₆ independently comprise single or branched non-fluorinated or fluorinated C₁-C₁₀ alkyl.

In one aspect, the lubricant described above wherein R₁, R₂, R₃, R₄, R₅ and R₆ each comprise methyl.

In one aspect, the lubricant described above wherein R₂ and R₃ comprise a divalent linking segment.

In one aspect, a magnetic recording medium, comprising: a magnetic recording layer on a substrate; a protective overcoat on the magnetic recording layer; and a lubricant layer comprising the lubricant described above on the protective overcoat.

In one aspect, a data storage system, comprising: at least one magnetic head; a magnetic recording medium including the lubricant described above; a drive mechanism for positioning the at least one magnetic head over the magnetic recording medium; and a controller electrically coupled to the at least one magnetic head for controlling operation of the at least one magnetic head.

In one aspect, data storage system, comprising: a slider comprising at least one magnetic head and an air bearing surface (ABS), wherein a lubricant described above is disposed on the ABS; and a magnetic recording medium including a magnetic recording layer; wherein the slider is configured to write information to the magnetic recording layer using heat assisted magnetic recording (HAMR), microwave assisted magnetic recording (MAMR), perpendicular magnetic recording (PMR), energy-assisted perpendicular magnetic recording (ePMR) or shingled magnetic recording (SMR).

In one aspect, a method of synthesizing a lubricant of the formula (Ia), comprising:

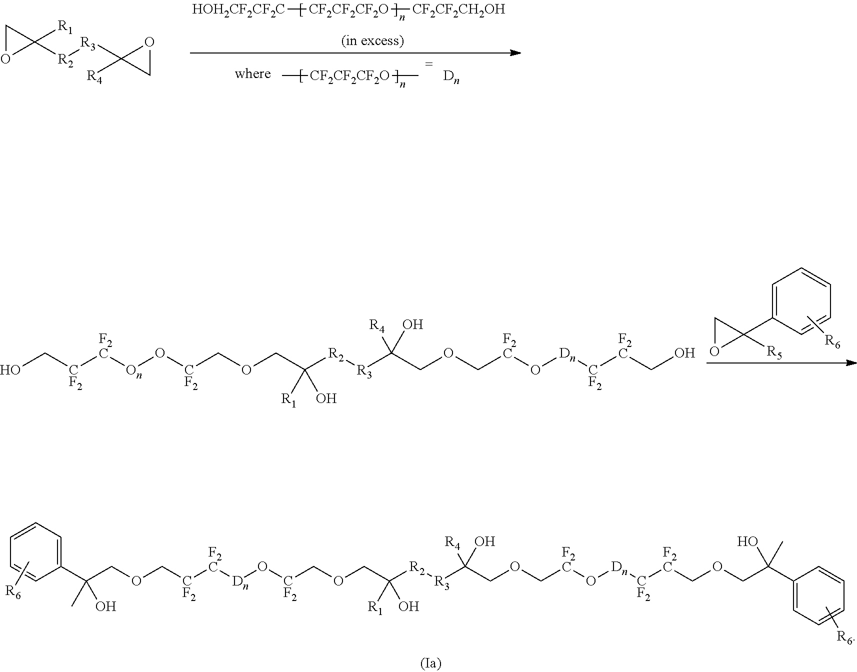

In one aspect, the lubricant described above wherein each reaction step is performed in t-butanol in the presence of potassium t-butoxide catalyst at 40° C. to 80° C. to yield a reaction mixture, and the reaction mixture is neutralized with acid, washed with alcohol, and the product of formula (Ia) as shown above is separated by vacuum distillation, column chromatography or supercritical fluid extraction.

In one aspect, an epoxide based lubricant according to one of general formulas (Ie) to

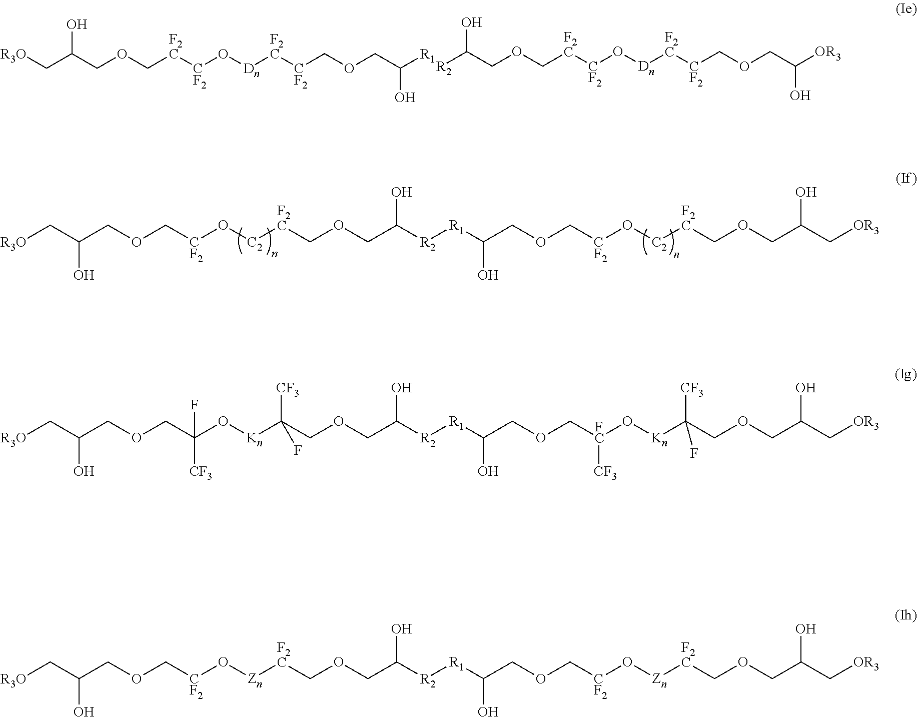

where Dₙ is —(CF₂CF₂CF₂O)ₙ—,
(C₂)ₙ is —(CF₂CF₂O)ₙ—,
Kₙ is —(CF₂CF(CF₃)O)ₙ—,
Zₙ is —(CF₂CF₂O)ₓ(CF₂O)_{y},
R₁, R₂, R₃, R₄, R₅ and R₆ independently comprise single or branched non-fluorinated or fluorinated C₁-C₁₀ alkyl, C₁-C₁₀ alkoxy, benzene, naphthalene, anthracene, phenanthrene, dibenz[a,h]anthracene, pyrene or benzopyrene, with n, x and y each independently being from 2 to 50.

In one aspect, a method of synthesizing a lubricant of the formula (Ie), comprising:

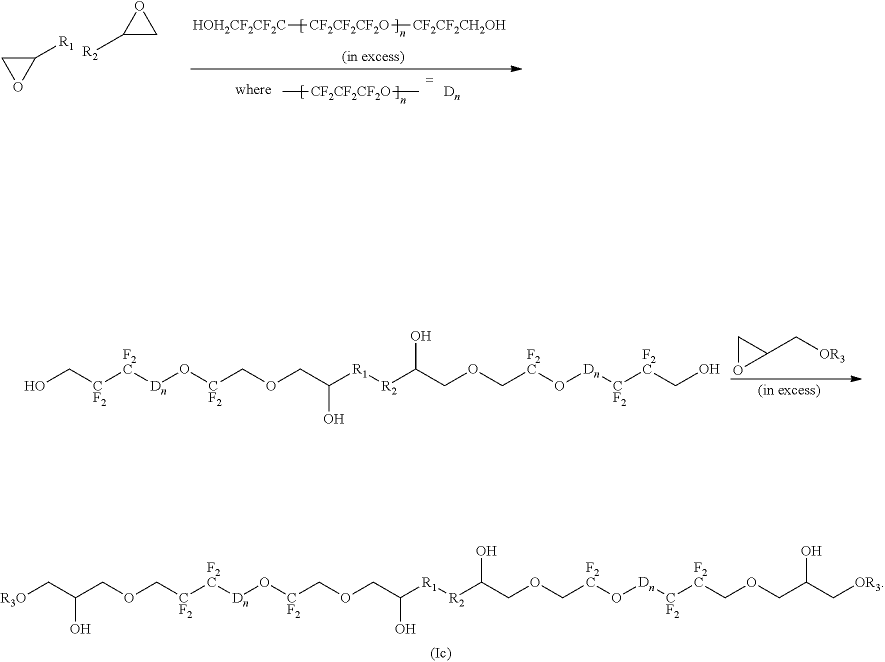

In one aspect, the lubricant described above wherein each reaction step is performed in t-butanol in the presence of potassium t-butoxide catalyst at 40° C. to 80° C. to yield a reaction mixture.

In one aspect, the lubricant described above wherein each reaction step is performed in t-butanol in the presence of potassium t-butoxide catalyst at 40° C. to 80° C. to yield a reaction mixture, and the reaction mixture is neutralized with acid, washed with alcohol, and the product of formula (Ia) is separated by vacuum distillation, column chromatography or supercritical fluid extraction.

In one aspect, a magnetic recording medium, comprising: a magnetic recording layer on a substrate; a protective overcoat on the magnetic recording layer; and a lubricant layer comprising the lubricant described above on the protective overcoat.

In one aspect, a data storage system, comprising: at least one magnetic head; a magnetic recording medium including the lubricant described above; a drive mechanism for positioning the at least one magnetic head over the magnetic recording medium; and a controller electrically coupled to the at least one magnetic head for controlling operation of the at least one magnetic head.

In one aspect, a data storage system, comprising: a slider comprising at least one magnetic head and an air bearing surface (ABS), wherein the lubricant described above is disposed on the ABS; and a magnetic recording medium including a magnetic recording layer; wherein the slider is configured to write information to the magnetic recording layer using heat assisted magnetic recording (HAMR).

In one aspect, an epoxide based lubricant according to general formula (Ia):

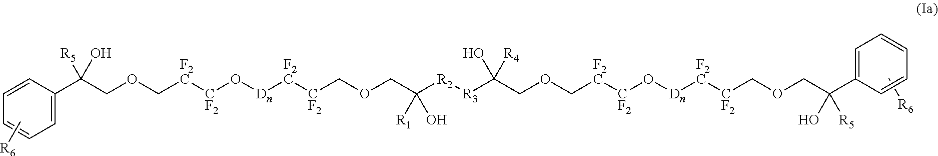

where D₁ is —(CF₂CF₂CF₂O)ₙ—,
R₁, R₂, R₃, R₄, R₅ and R₆ independently comprise single or branched non-fluorinated or fluorinated C₁-C₁₀ alkyl, C₁-C₁₀ alkoxy, benzene, naphthalene, anthracene, phenanthrene, dibenz[a,h]anthracene, pyrene or benzopyrene, with n being from 2 to 50.

In one aspect, the lubricant described above wherein R₁, R₂, R₃, R₄, R₅ and R₆ independently comprise single or branched non-fluorinated or fluorinated C₁-C₁₀ alkyl, or R₁, R₂, R₃, R₄, R₅ and R₆ each comprise methyl or benzyl.

In one aspect, the lubricant described above wherein R₂ and R₃ comprise a divalent linking segment.

### BRIEF DESCRIPTION OF THE DRAWINGS

FIG. 1A is a diagram schematically illustrating a data storage device including a slider and a magnetic recording medium in accordance with one aspect of the disclosure.

FIG. 1B is a side schematic view of the slider and magnetic recording medium of FIG. 1A in accordance with one aspect of the disclosure.

FIG. 2 is a side schematic view of a head assisted magnetic recording (HAMR) medium in accordance with one aspect of the disclosure.

FIG. 3A is a schematic drawing showing a lubricant according to general formula (II) of the disclosure comprising a single main chain segment and a cyclic functional group according to one aspect of the disclosure.

FIG. 3B is a schematic drawing showing a lubricant according to general formula (II) of the disclosure comprising a single main chain segment and a multitude of cyclic functional groups according to one aspect of the disclosure.

FIG. 3C is a schematic drawing showing a lubricant according to general formula (III) of the disclosure comprising two chain segments comprising terminal cyclic functional groups and separated by a linking segment according to one aspect of the disclosure.

FIG. 3D is a schematic drawing showing a lubricant according to general formula (III) of the disclosure comprising two chain segments comprising terminal cyclic functional groups and separated by a linking segment comprising cyclic functional groups according to one aspect of the disclosure.

FIG. 3E is a schematic drawing showing a lubricant according to general formula (IV) of the disclosure comprising two chain segments comprising terminal cyclic functional groups and separated by a linking segment according to one aspect of the disclosure.

FIG. 4 is a graph showing the results for the thermogravimetric analysis (TGA) of a fluorinated lubricant compared to a non-fluorinated lubricant and a non-fluorinated lubricant containing benzene rings, according to aspects of the disclosure.

FIG. 5 shows the lifetime results of various test lubricants grouped by lubricant type, according to aspects of the disclosure.

FIG. 6 is a thermogravimetric analysis (TGA) graph that compares the decomposition temperature for different types of lubricants under air as compared to nitrogen (N₂), according to aspects of the disclosure.

FIG. 7 is a flowchart of an exemplary process for fabricating a HAMR medium that includes a magnetic recording layer, a capping layer, an overcoat and a lubricant, in accordance with an aspect of the disclosure.

### DETAILED DESCRIPTION

Heat Assisted Magnetic Recording (HAMR) systems operate at substantially higher temperatures than traditional magnetic recording systems. HAMR is an example of magnetic recording within the class of Energy Assisted Magnetic Recording (EAMR) techniques, where conventional magnetic recording is supplemented by other energy used in the system. Other examples of EAMR may include Microwave Assisted Magnetic Recording (MAMR) and applications of electric current into various conductive and/or magnetic structures near the main pole. This disclosure is generally directed to lubricants having high thermal stability that can be used in conjunction with a magnetic recording medium and/or a magnetic data storage system including a HAMR, or more generally EAMR, magnetic recording medium or storage system.

The extremely high operational temperatures associated with the use of HAMR pose great challenges on the reliability of all components at the head disk interface (HDI). The HDI may include the disk/media surface, including for example, a lubricant layer on a protective overcoat of the media, and a slider/head that flies extremely close to the media surface as it rotates. One of the major causes of HDD drive failures is head smear (e.g., contamination from the media or elsewhere in the HDD that gets on, and interferes with operation of, the head). As the weakest part in the HDI, the media lubricant contributes to or facilitates a large portion of the head smear formation. HDD level tests show a clear correlation between lubricant thermal stability and drive life time, suggesting the enhancement of lubricant thermal stability can serve as a significant enabler for longer HAMR drive life time. Thermal studies suggest that oxidation of lubricant plays an important role in the lube loss/thermal decomposition process. And lubricants lose weight more slowly in the inert atmosphere. While current HAMR drive atmospheres may have oxygen, new lubricant structures with higher oxidation resistance are desired to improve the thermal stability in HDD drive environments.

In short, the disclosure pertains to lubricants with a stiffened chain obtained via epoxide chemistry. The lubricants can provide improved thermal stability as compared to existing lubricants.

In one aspect, one such epoxide based lubricant comprises or is according to general formulas (Ia) to (Id):

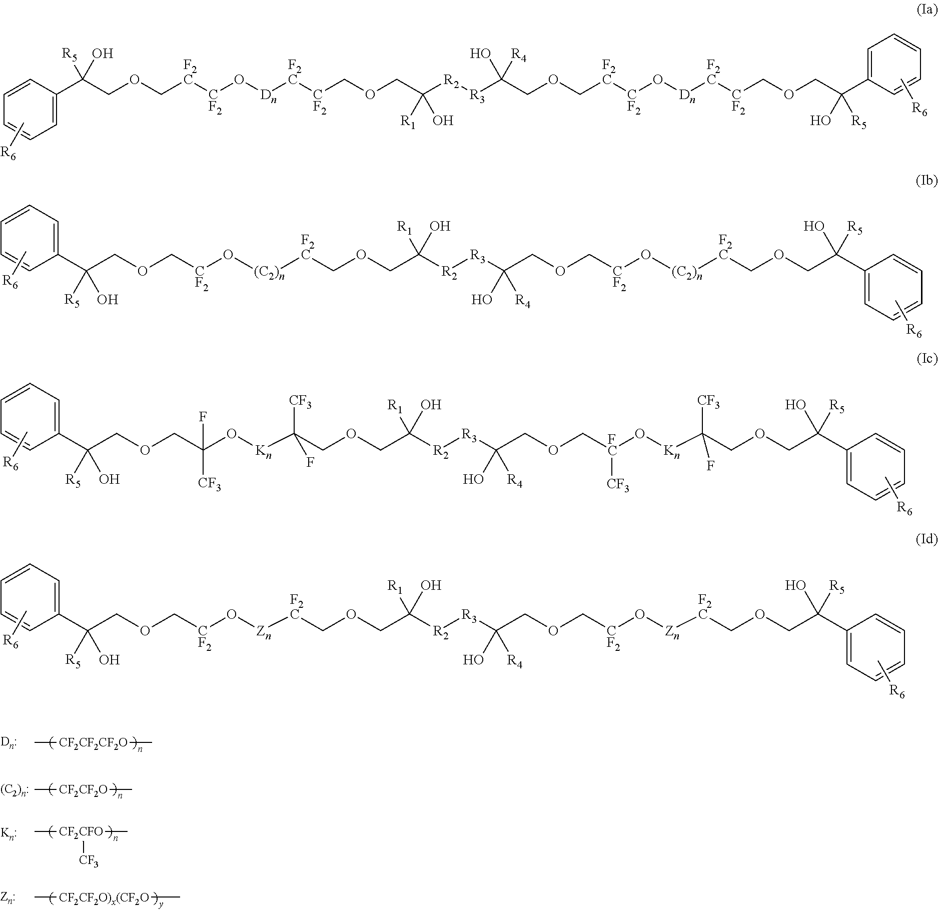

where R₁, R₂, R₃, R₄, R₅ and R₆ independently comprise single or branched non-fluorinated or fluorinated C₁-C₁₀ alkyl, C₁-C₁₀ alkoxy, benzene, naphthalene, anthracene, phenanthrene, dibenz[a,h]anthracene, pyrene or benzopyrene. Dₙ is a perfluoroether group, e.g., —CF₂CF₂O—, —CF₂CF₂CF₂O—, etc. (or —(CF₂)ₘO— with m being 2 to 10) and n, x and y each independently being from 2 to 50. More backbone repeating units can be included, such as C1/C2, KRYTOX (perfluoropolyether), etc.

The modified lubricant molecule has similar anchoring (4 —OH groups at the same position of the lubricant) while possessing fewer weak ether bonds (4 versus the 8 of conventional art lubricants) and less tendency for oxidation (4 tertiary —OH).

In one aspect, one such epoxide based lubricant comprises or is according to general formulas (Ie) to (Ih):

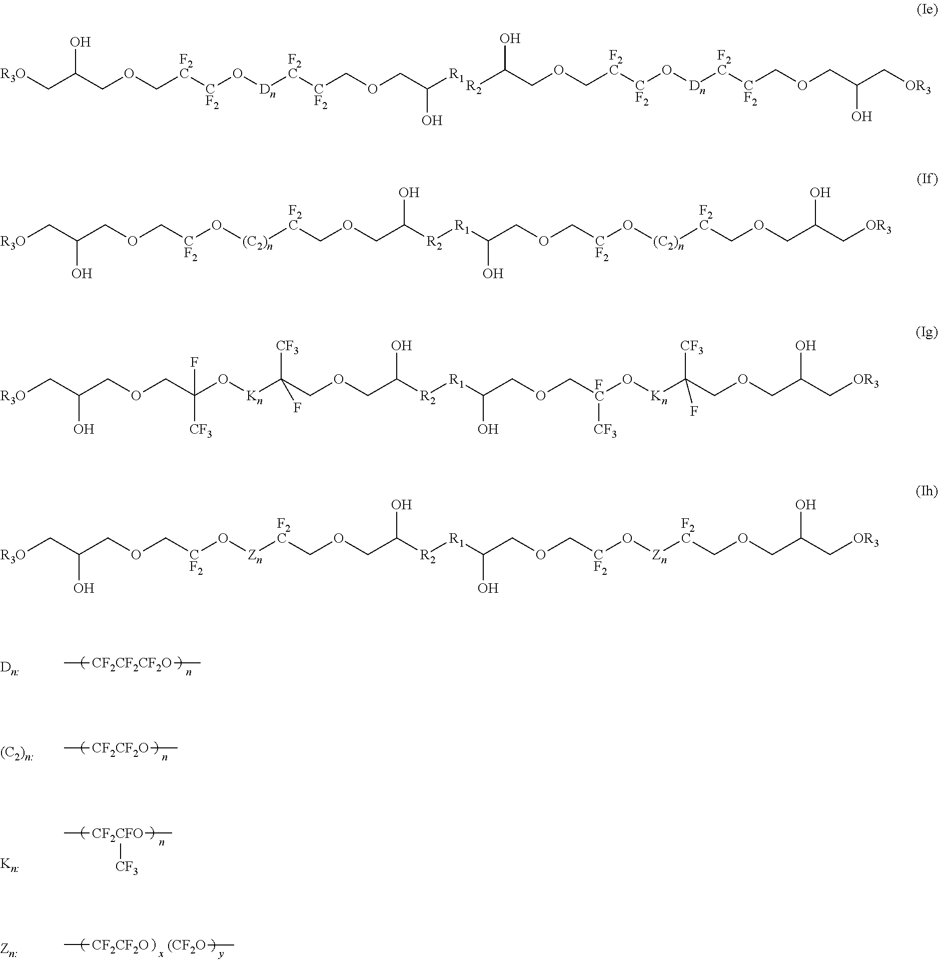

where R1, R2, R3 and Dₙ are defined as above and n is from 2 to 50.

Formulas (Ia) to (Ih) possess fewer weak ether bonds than the conventional lubricants.

### Definitions

As used herein, and unless otherwise specified, the term “Cₙ” means hydrocarbon(s) having n carbon atom(s) per molecule, where n is a positive integer. Likewise, a “Cₘ-C_{y}” group or compound refers to a group or compound comprising carbon atoms at a total number thereof in the range from m to y. Thus, a C₁-C₄ alkyl group refers to an alkyl group that includes carbon atoms at a total number thereof in the range of 1 to 4, e.g., 1, 2, 3 and 4.

“Moiety” refers to one or more covalently bonded atoms which form a part of a molecule. The terms “group,” “radical,” “moiety”, and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₅₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl naphthyl, and the like.

For purposes herein, a “heteroatom” is any non-carbon atom, selected from groups 13 through 17 of the periodic table of the elements. In one or more aspects, heteroatoms are non-metallic atoms selected from B, Si, pnictogens (N, P, As, Sb, Bi), chalcogen (O, S, Se, Te), and halogens (F, Cl, Br, I).

Unless otherwise indicated, the term “substituted” means that at least one hydrogen atom has been replaced with at least one non-hydrogen atom or a functional group.

For purposes herein, when a segment comprises or includes a particular moiety, it is to be understood that the moiety may be bonded to the respective segment at any substitutable position in which a hydrogen atom may be replaced with a chemical bond between the moiety and the segment.

For purposes herein, a functional group includes one or more of a hydrocarbyl group, a heteroatom, or a heteroatom containing group, such as B, Si, pnictogen, chalcogen, or halogen (such as Br, Cl, F or I), at least one of —OR*, —NR*₂, —NR*—CO—R*, —OR*, R*—O—CO—R*, —CO—O—R*, —SeR*, —TeR*, —PR*₂, other P(III) groups including —PO—(OR*)₂ and —O—PO—(OR*)₂, —N═P(NR*₂)₃, AsR*₂, —SbR*₂, —SR*, —SO₂—(OR*)₂, —BR*₂, —SiR*₃, —(CH₂)_{q}—SiR*₃, or a combination thereof, wherein q is 1 to 10 and each R* is independently a hydrogen, a hydrocarbyl or a halocarbyl radical, and two or more R* may join together to form a substituted or unsubstituted completely saturated, partially unsaturated, or aromatic cyclic or polycyclic ring structure, or where at least one heteroatom has been inserted within a hydrocarbyl ring. In an aspect, R* is H such that the functional group may be —OH, —NH₂, —NH—CO—H, —OH, H—O—CO—H, —CO—O—H, —SeH, —TeH, —PH₂, other P(III) groups including —PO—(OH)₂ and —O—PO—(OH)₂, —N═P(NR*₂)₃, —AsH₂, —SbH₂, —SH, —SO₂—(OH)₂, —BH₂, —SiH₃, —(CH₂)_{q}—SiH₃, or a combination thereof

In one or more aspects, functional groups may include: a saturated C₁-C₅₀ radical, an unsaturated C₁-C₅₀ radical, an alicyclic C₃-C₅₀ radical, a heterocyclic C₃-C₅₀ radical, an aromatic C₅-C₅₀ radical, a heteroaromatic C₅-C₅₀ radical, a cyclotriphosphazine radical, a B, Si, pnictogen, chalcogen, or halogen, —OR*, —NR*₂, —NR*—CO—R*, —OR*, —O—CO—R*, —CO—O—R*, —SeR*, —TeR*, —PR*₂, P(III) groups including —PO—(OR*)₂, and —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen, a chalcogen, a halogen, or a saturated, unsaturated, aromatic, polycyclic aromatic, heteroaromatic, alicyclic, and/or heterocyclic C₄-C₅₀ radical. Anchoring functional groups can also be least one of —OH, —NH₂, —NH—CO—H, —O—CO—H, —CO—O—H, —SeH, —TeH, —PH₂, of the P(II) groups including —PO—(OH)₂ and —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof.

For purposes herein, a cyclic functional group is a monovalent alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. Unless otherwise indicated, the cyclic functional group may be further substituted with another cyclic functional group and/or with one or more functional groups comprising one or more of a saturated C₁-C₅₀ radical, an unsaturated C₁-C₅₀ radical, an alicyclic C₃-C₅₀ radical, a heterocyclic C₃-C₅₀ radical, an aromatic C₅-C₅₀ radical, a heteroaromatic C₅-C₅₀ radical, a cyclotriphosphazine radical, B, Si, a pnictogen, a chalcogen, or a halogen, —OR*, —NR*₂, —NR*—CO—R*, —OR*, —O—CO—R*, —CO—O—R*, —SeR*, —TeR*, —PR*₂, other P(III) groups including —PO—(OR*)₂ and —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, or a saturated, unsaturated, aromatic, polycyclic aromatic, heteroaromatic, alicyclic, and/or a heterocyclic C₁-C₅₀ radical.

For purposes as described herein, an anchoring functional group which is selected for being attachable to and/or engageable with a protective overcoat of a magnetic recording medium refers to a functional group having increased affinity for the protective overcoat of a magnetic recording medium relative to the affinity of a fluoroalkenyl ether moiety, a perfluoroalkyl ether moiety, a perfluoroalkenyl ether moieties, to that same surface. Increased affinity may include Van der Waals forces, weak London Dispersion forces, dipole-dipole forces, polar interactions, polarizability/hydrogen bonding interactions, and/or the like, and/or may include the formation of one or more types of bonds, backbonding (the exchange of electrons between an atomic orbital on one atom and an anti-bonding orbital on another atom), and/or dative bonds (a covalent bond (a shared pair of electrons) in which both electrons come from the same atom) with the protective overcoat of a recording medium. In one or more aspects, a functional group which is attachable to and/or engageable with a protective overcoat of a magnetic recording medium refers to one or more functional groups having increased affinity for the carbon overcoat (COC) layer of the recording medium, relative to the affinity of a fluoroalkenyl ether moiety, a perfluoroalkyl ether moiety, a perfluoroalkenyl ether moieties to that same surface. In some aspects, functional groups attachable to and/or engageable with a protective overcoat of a magnetic recording medium include radicals comprising one or more hydroxyl moieties (—OH), or comprising a hydroxyl moiety (—OH).

A “heterocyclic ring,” also referred to herein as a heterocyclic radical, is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring is a heterocyclic ring where a hydrogen of one of the ring atoms is substituted, e.g., replaced with a hydrocarbyl, or a heteroatom containing group.

A “compound” refers to a substance formed by the chemical bonding of a plurality chemical elements. A “derivative” refers to a compound in which one or more of the atoms or functional groups of a precursor compound have been replaced by another atom or functional group, generally by means of a chemical reaction having one or more steps.

Fluorinated alkyl ethers including fluoroalkyl ethers, fluoroalkenyl ethers, perfluoroalkyl ethers, perfluoroalkenyl ethers, or combinations thereof, refer to branched or linear chain of C₁ to C₂₀ alkyl ethers in which one or more hydrogen atoms are substituted with fluorine. In one aspect, all or a majority of alkyl hydrogen atoms are substituted with fluorine.

For any particular compound disclosed herein, any general or specific structure presented also encompasses all conformational isomers, regio-isomers, and stereoisomers that may arise from a particular set of substituents, unless stated otherwise. Similarly, unless stated otherwise, the general or specific structure also encompasses all enantiomers, diastereomers, and other optical isomers whether in enantiomeric or racemic forms, as well as mixtures of stereoisomers, as would be recognized by a skilled artisan.

As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

As used herein, a moiety which is chemically identical to another moiety is defined as being identical in overall composition exclusive of isotopic abundance and/or distribution, and/or exclusive of stereochemical arrangement such as optical isomers, confirmational isomers, spatial isomers, and/or the like.

### System for Employing Lubricant

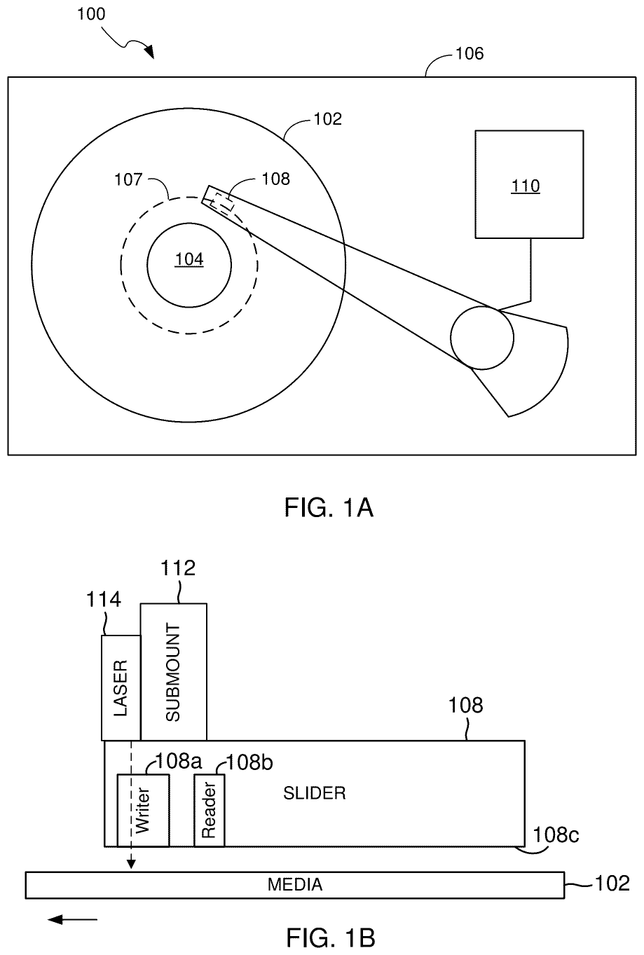

FIG. 1A is a top schematic view of a data storage device 100 (e.g., disk drive or magnetic recording device) configured for heat assisted magnetic recording (HAMR). The system includes a slider 108 and a magnetic recording medium 102 having a lubricant according to one or more aspects of the disclosure. The laser (not visible in FIG. 1A but see 114 in FIG. 1B) is positioned with a head/slider 108. Disk drive 100 may include one or more disks/media 102 to store data. The disks/media 102 reside on a spindle assembly 104 that is mounted to a drive housing. Data may be stored along tracks in the magnetic recording layer of disk 102. The reading and writing of data is accomplished with the head 108 (slider) that may have both read and write elements (108a and 108b). The write element 108a is used to alter the properties of the magnetic recording layer of disk 102 and thereby write information thereto. In one aspect, head 108 may have magneto-resistive (MR), giant magneto-resistive (GMR), or tunnel magneto-resistive (TMR) elements. In an alternative aspect, head 108 may be another type of head, for example, a Hall effect head. In operation, a spindle motor (not shown) rotates the spindle assembly 104, and thereby rotates the disk 102 to position the head 108 at a particular location along a desired disk track 107. The position of the head 108 relative to the disk 102 may be controlled by the control circuitry 110 (e.g., a microcontroller). It is noted that while an example HAMR system is shown, the various embodiments described may be used in other EAMR or non-EAMR magnetic data recording systems, as mentioned above, including PMR and ePMR disk drives or magnetic tape drives.

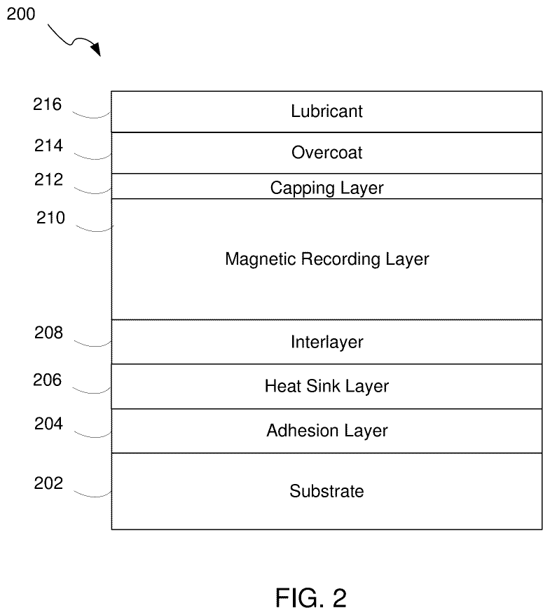

FIG. 1B is a side schematic view of the slider 108 and magnetic recording medium 102 of FIG. 1A. The magnetic recording medium 102 includes a lubricant layer (see FIG. 2) in accordance with one or more aspects of the disclosure. The slider 108 may include a sub-mount 112 attached to a top surface of the slider 108. The laser 114 may be attached to the sub-mount 112, and possibly to the slider 108. The slider 108 includes a write element (e.g., writer) 108a and a read element (e.g., reader) 108b positioned along an air bearing surface (ABS) 108c of the slider for writing information to, and reading information from, respectively, the medium 102. In other aspects, the slider may also include a layer of the lubricant (not shown).

In operation, the laser 114 is configured to generate and direct light energy to a waveguide (possibly along the dashed line) in the slider which directs the light to a near field transducer (NFT) near the air bearing surface (e.g., bottom surface) 108c of the slider 108. Upon receiving the light from the laser 114 via the waveguide, the NFT generates localized heat energy that heats a portion of the medium 102 near the write element 108a and the read element 108b. The anticipated recording temperature is in the range of about 350° C. to 400° C. In the aspect illustrated in FIG. 1B, the laser directed light is disposed between the writer 108a and a trailing edge of the slider. In other aspects, the laser directed light may instead be positioned between the writer 108a and the reader 108b. FIGS. 1A and 1B illustrate a specific aspect of, e.g., a HAMR system. In other aspects, the magnetic recording medium 102 with the lubricant layer according to aspects of the disclosure can be used in other suitable HAMR systems (e.g., with other sliders configured for HAMR). Also, the technology is not restricted to HAMR systems, but can also be applied to other systems.

FIG. 2 is a side schematic view of a magnetic recording medium 200 having a lubricant layer according to one or more aspects of the disclosure. In one aspect, the magnetic recording medium 200 may be used in, for example, a HAMR system (e.g., disk drive 100). The magnetic recording medium 200 has a stacked structure with a substrate 202 at a bottom/base layer, an adhesion layer 204 on the substrate 202, a heat sink layer 206 on the adhesion layer 204, an interlayer 208 on the heat sink layer 206, a magnetic recording layer (MRL) 210 on the interlayer 208, a capping layer 212 on the MRL 210, an overcoat layer 214 on the capping layer 212, and a lubricant layer 216 on the overcoat layer 214. In one aspect, the magnetic recording medium 200 may have a soft magnetic underlayer (SUL) between the adhesion layer 204 and the heat sink layer 206. In one aspect, the magnetic recording medium 200 may have a thermal resistance layer (TRL) between the interlayer 208 and the heat sink layer 206. In one aspect, for disk drive applications, the substrate 202 can be made of one or more materials such as an Al alloy, NiP plated Al, glass, glass ceramic, and/or combinations thereof. In one aspect for magnetic tape recording applications, the substrate 202 can include a flexible material, such a film made of one of various types of resins, polyesters, polyolefins, polyamides, and the like, or combinations thereof. The substrate may include non-magnetic materials, and may be laminated. In some aspects, the magnetic recording medium 200 may have some or all of the layers illustrated in FIG. 2 and/or additional layer(s) in various stacking orders. It should also be noted that each layer shown in FIG. 2 may include one or more sub-layers. For example, the magnetic recording layer may comprise a multiple layers in certain embodiments. Also, some of the layers may be etched before the next layer is applied.

### Lubricants

Lubricants according to aspects disclosed herein may function as boundary lubricants which may be used in various mechanical devices, including on the magnetic media of hard disk drives or tape drives and in conjunction with other microelectronic mechanical systems. Boundary lubricants may form a lubricant layer when one or more functional groups of the lubricant attach or otherwise engage with the surface being lubricated. For instance, one or more boundary lubricants may form the lubricant layer 216 on magnetic recording medium 200 (e.g., a disk that includes a magnetic recording layer 210) that moves relative to other parts in the magnetic storage device. This lubricant layer 216 may help to protect the magnetic recording medium from friction, wear, contaminations, smearing, and/or damages caused by interactions between the magnetic recording medium and other parts in the storage device (e.g., interactions between a slider and the magnetic recording medium). In other words, this boundary layer may help limit solid-to-solid contact.

While the HDD examples illustrated in FIGS. 1A, 1B, and 2 primarily relate to HAMR technology that involves the use of lubricants, the lubricants described herein may also be used in other magnetic recording technologies. These may include Microwave Assisted Magnetic Recording (MAMR), Perpendicular Magnetic Recording (PMR), Enterprise Perpendicular Magnetic Recording (ePMR), Shingled Magnetic Recording (SMR), or any other magnetic recording technology employing lubricants on magnetic media (e.g., magnetic recording disks or magnetic recording tape).

### Lubricant Characteristics

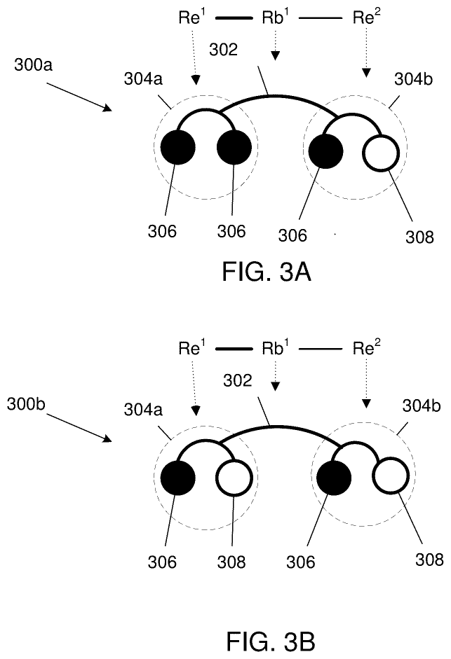

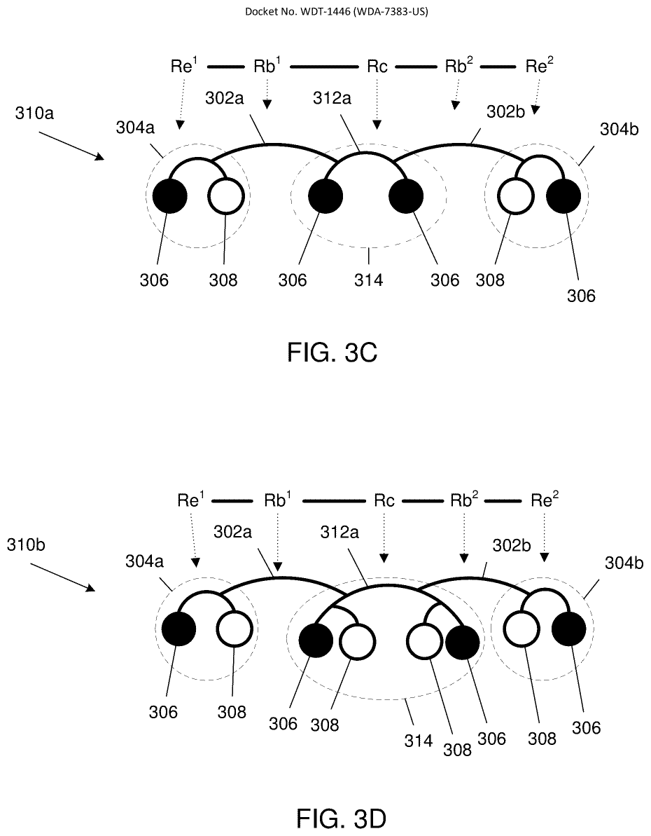

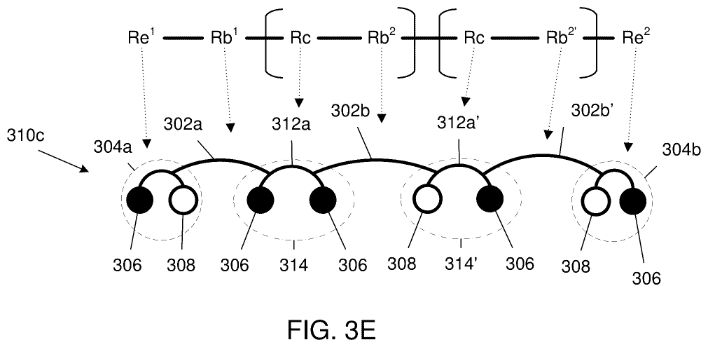

FIG. 3A-3D illustrate boundary lubricants according to aspects of the disclosure. In one aspect as shown in FIG. 3A, the boundary lubricant generally referred to as 300a comprises or may have general formula (II):

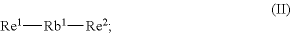

wherein Rb¹ (302) comprises or is a chain segment including an alkyl, alkenyl, fluoroalkyl, fluoroalkenyl, perfluoroalkyl, or perfluoroalkyl ether moiety bonded on either side to an end segment 304a and 304b. Rb¹ may be non-fluoridated, contain anchoring functional groups and contain aromatic, e.g., benzene, rings. Rb¹ may also have a stiffening component that has a higher rotational energy than CH₂. In the aspect shown in FIG. 3A, the chain segment Rb¹ (302) may be also be referred to as a main chain segment. Each of Re¹ (304a) and Re² (304b) is an end segment which independently includes an anchoring functional group 306 selected for being attachable to and/or engageable with a protective overcoat of a magnetic recording medium (see FIG. 2).

As shown in FIG. 3B, in one aspect indicated as 300b, each end group segment may include a functional group 308 that can be as simple as an —OH group.

In one aspect as shown in FIG. 3C, the boundary lubricant generally referred to as 310a may comprise or has general formula (III):

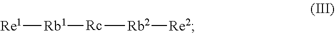

where the end segments Re¹ (304a) and Re² (304b) are as described above; in this aspect there are two chain segments Rb¹ (302a) and Rb² (302b), which may also be referred to herein as sidechain segments, both of which independently comprises a fluoroalkyl, fluoroalkenyl, perfluoroalkyl, or perfluoroalkyl ether moiety.

As is indicated in FIG. 3C, whether referred to as a chain segment, a main chain segment (when only one is present), or a sidechain segment (when two or more are present), each of the segments are similar to one another in that each segment comprises an alkyl, alkenyl, fluoroalkyl, fluoroalkenyl, perfluoroalkyl, or perfluoroalkyl ether moiety.

In the aspect shown in FIG. 3C, the lubricant may further include a divalent linking segment Rc (312), generally indicated as 314, also referred to herein as a center segment, which is disposed between either end of the sidechain segments 302a and 302b, and which includes at least one anchoring functional group (306) as defined herein, as well as at least one group that has a higher rotational energy than CH₂, which for example can be an aromatic group, e.g., benzene. In an embodiment, Rc is non-fluorinated. The divalent linking segment optionally includes aromatic moieties which act to stiffen the center of the molecule. The aromatic moieties, e.g., benzene, impact both the chain stiffness and solubility differently than fluorination.

As shown in FIG. 3D, in one aspect generally indicated as 310b, the divalent linking segment Rc (312) may further include at least one functional group 308 as defined herein.

In one aspect as shown in FIG. 3E, the boundary lubricant generally referred to as 310c may comprise or has general formula (IV):

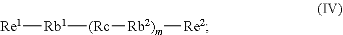

wherein m=2, comprising two units of the divalent linking segments, each containing an aromatic moiety or a moiety that has a higher rotational energy than CH₂; a first unit comprising Rc (312a) also generally indicated as (314), attached to a chain segments Rb² (302b), which is attached to a second unit comprising Rc (312a′) also generally indicated as (314′) and a second chain segment Rb^{2′} (302b′). The second unit includes a moiety that has a rotational energy barrier that is greater than that of CH₂. The end segments Re¹ (304a) and Re² (304b) are attached to ether end of the molecule. The composition of each of the segments may be independent of one another. The composition of each of the segments is according to the description of general formula (I) herein. In an embodiment, Rc contains at least one anchoring functional group, is non-fluorinated and contains at least one aromatic constituent, e.g., a benzene ring. In an embodiment, Rc contains two aromatic constituents.

In one aspect, each anchoring functional group may independently comprises a B, Si, pnictogen, chalcogen, or halogen, —OR*, —NR*₂, —NR*—CO—R*, —OR*, —O—CO—R*, —CO—O—R*, —SeR*, —TeR*, —PR*₂, other P(III) groups including —PO—(OR*)₂ and —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, or a saturated, unsaturated, aromatic, polycyclic aromatic, heteroaromatic, alicyclic, and/or heterocyclic C₁-C₅₀ radical, and two or more R* may join together to form a ring structure. Frequently, the anchoring functional group may be hydroxyl (—OH).

In one aspect, each cyclic functional group may further comprise, e.g., may be further substituted with a functional group comprising at least one of a B, Si, pnictogen, chalcogen, or halogen, —OH, —NH₂, —NH—CO—H, —OH, —O—CO—H, —CO—O—H, —SeH, —TeH, —PH₂, other P(III) groups including —PO—(OH)₂ and —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof, wherein q is 1 to 10.

In one aspect, one or more anchoring functional group may include, or is, a hydroxyl (—OH) moiety. In one aspect, each anchoring functional group includes or is a hydroxyl (—OH) moiety. In some aspects, one or more cyclic functional groups may comprise a hydroxyl (—OH) moiety. In some aspects, each cyclic functional group comprises a hydroxyl (—OH) moiety.

### Aromatic Functional Groups

Applicants have discovered that the presence of functional groups having high rotational energy barriers, e.g., aromatic functional groups, in the center of the molecule provide a multifaceted benefit for applications involving higher operational temperatures (e.g., such as HAMR media applications or high oxidation resistance for ePMR) when the aromatic functional groups are present in the center or linking segment pendant to the chain segments according to aspects disclosed herein. It has been discovered that the aromatic functional groups reduce the contamination present on the magnetic recording medium when operating at high temperatures. The disclosure is not restricted to aromatic groups, and any group that has a higher rotational energy than CH₂ will also achieve the molecular stiffening that enhances high temperature performance. The high rotational energy barrier is one aspect of the benefits of aromatic groups. Other benefits include high thermal stability, high boiling point, interaction with COC, etc.

In one aspect, a cyclic aromatic functional group may include substituted or unsubstituted analogs of borirene, cyclopropenone, furan, pyrrole, imidazole, thiophene, phosphole, pyrazole, oxazole, isoxazole, thiazole, triazole, tetrazole, pentazole, benzene, pyridine, pyrazine, pyrimidine, pyridazine, triazine, tetrazine, pentazine, hexazine, borepin, tropone, azonine, cyclooctadecanonaene, diazapentalene, thienothiophene, trithiapentalene, benzofuran, isobenzofuran, indole, isoindole, benzothiophene, benzo(c)thiophene, benzophosphole, benzimidazole, purine, indazole, benzoxazole, benzisoxazole, benzothiazole, 5-aza-7-deazapurine, naphthalene, quinoline, isoquinoline, quinoxaline, quinazoline, cinnoline, phthalazine, azulene, combinations thereof, and/or the like. According to aspects of the disclosure, the aromatic group may be anisole, benzene, naphthalene, anthracene, phenanthrene, dibenz[a,h,]anthracene, pyrene or benzopyrene.

### Smear

HDDs including HAMR drives, when coated with lubricant, may be exposed to laser radiation on the medium over varying amounts of time, and the intensity of the laser radiation result in the production of a nitrogenated carbonaceous material (CNₓ) smear problem. These above noted chemistries can be used to address the HDD smear problem. The mechanism works on the surface of a magnetic recording medium that has a magnetic layer topped with a capping layer, a protective carbon overcoat layer and a layer of lubricant, as can be seen in FIG. 2. Under laser irradiation (e.g., high heat from a near field transducer or NFT) at some initial time, nitrogenated carbonaceous material may be formed in the carbon overcoat layer. As time proceeds, more nitrogenated carbonaceous material may be formed, and some of the nitrogenated carbonaceous material and some of the lubricant make their way on to the NFT. This smear deteriorates the performance of the medium and the HDD system (e.g., operation of the slider, NFT and medium to record and read information), such that the flying height (FH) of the slider/NFT gradually increases. This increased flying height lowers the recording performance of the HDD system since the read and write operations on the media occur at a greater distance from the slider (containing the NFT and read and write elements).

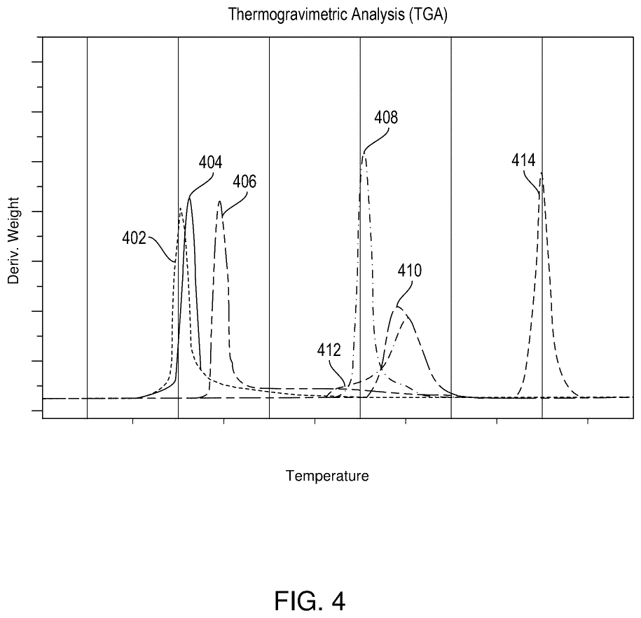

FIG. 4 is a graph showing the results for the thermogravimetric analysis (TGA) of a fluorinated lubricant compared to a non-fluorinated lubricant and a non-fluorinated lubricant containing benzene rings, according to aspects of the disclosure. The problems noted above are further elucidated in the thermogravimetric analysis (TGA) graph in FIG. 4. Lubricants include perfluorinated polyether (PFPE) with —OH anchoring groups 402, PFPE lubricant 404 and PFPE backbone with anchoring groups 406. Non-fluorinated polyurethane lubricant 408 has a peak at 300° C. Non-fluorinated lubricant 410 and non-fluorinated lubricant with benzene rings 412 come off at less than 350° C. The ideal lubricant 514 will not change until 400° C.

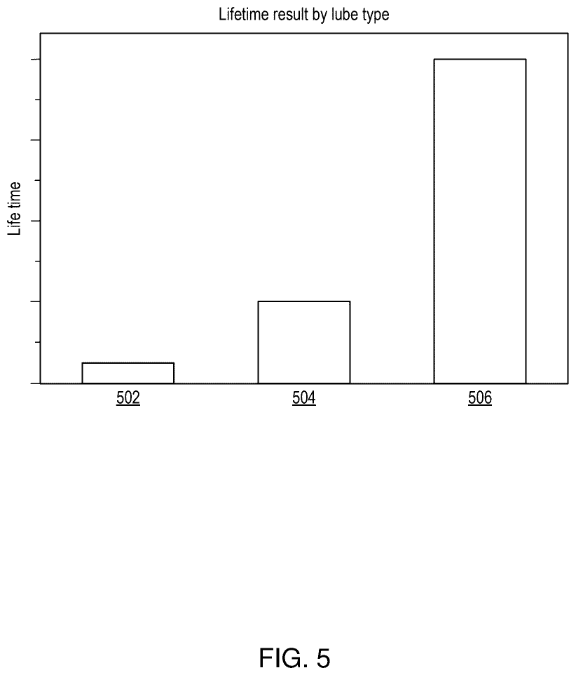

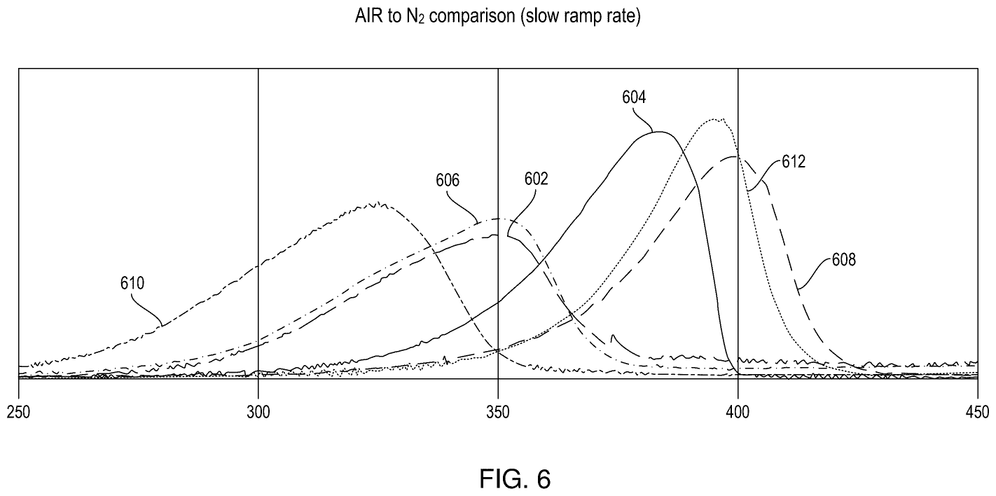

FIG. 5 shows the lifetime of various test lubricants grouped by lubricant type, according to aspects of the disclosure. The lifetime was determined by placing the lubricant on a magnetic recording medium of a magnetic storage device configured for HAMR (e.g., hard disk drive or HDD) and measuring the time to failure under elevated conditions. The PFPE with —OH anchoring groups control 502 had a mean lifetime of less than 100 hours. The PFPE backbone with anchoring groups 504 did better with some samples lasting up to 800 hours. Better results were seen for the nonfluorinated polyurethane lubricant samples 506, almost all of which lasted 800 hours. The results in FIG. 5 and FIG. 6 show that by introducing various new lube designs as presented herein, the thermal stability of the lubricants improved dramatically. A strong correlation between HDD lifetime result and lubricant TGA peak temperature is observed. This observation not only applies to HAMR but also applies to other magnetic recording systems.

FIG. 6 is a TGA graph that compares the decomposition temperature for different types of lubricants under air as compared to nitrogen (N₂), according to aspects of the disclosure. Oxidation facilitates lubricant thermal decomposition. The FIG. 6 graph shows TGA curves for lubricants in air compared to an inert atmosphere (N₂), using a slow ramp rate (fast and slow ramp rates are described in greater detail below). For example, a non-fluorinated lubricant with benzene in air 602 can be compared to a non-fluorinated lubricant with benzene in N₂ 604. A non-fluorinated lubricant with no benzene in air 606 can be compared to non-fluorinated lubricant with no benzene in N₂ 608. A non-fluorinated lubricant in air 610 can be compared to a non-fluorinated lubricant in N₂ 612. In all cases there is a dramatic shift in air versus N₂, where the TGA peaks between 30° and 350° C. in air effectively shift to the right to decompose up to 400° C.

The TGA peak derivative temperatures under different conditions are also set forth in Table 1.

TABLE 1
TGA results at a slow ramp rate.

| | | Non- | Non- | |
|---|---|---|---|---|
| | | fluorinated | fluorinated | Non- |
| | | with no benzene | with benzene | fluorinated |
| Ramp Rate | Atmosphere | rings (° C.) | rings (° C.) | (° C.) |
| slow | N₂ | 397 | 399 | 383 |
| | Air | 350 | 350 | 325 |
| | T_{N2} − Tₐᵢᵣ | 47 | 49 | 58 |

As can be seen in Table 1, air promotes the decomposition of lubricant, with the oxygen in the air acting as an oxidizing agent. The effect of ramp rate, i.e., rate of heating, can be observed in Table 2.

TABLE 2
The effect of ramp rate on TGA results.

| | | Non- | Non- | |
|---|---|---|---|---|
| | | fluorinated | fluorinated | Non- |
| | | with no benzene | with benzene | fluorinated |
| Atmosphere | Ramp Rate | rings (° C.) | rings (° C.) | (° C.) |
| N₂ | Slow | 397 | 399 | 383 |
| | Fast | 412 | 407 | 389 |
| | T_{fast} − T_{slow} | 15 | 8 | 6 |
| Air | Slow | 350 | 350 | 325 |
| | Fast | 397 | 381 | 377 |
| | T_{fast} − T_{slow} | 47 | 31 | 52 |

As can be seen in Table 2, unimolecular-decomposition or evaporation is less sensitive to ramp-rate in inert atmosphere. Increasing lubricant oxygen resistance can improve thermal stability. In one aspect, the slow ramp rate is greater than zero and the fast ramp rate is at least twice that of the slow ramp rate.

### Bond Breaking During Thermal Decomposition

The mechanism of lubricant decomposition in an oxidative environment is initiated by an oxidative attack at the weak ether bonds, as can be seen in formula (V):

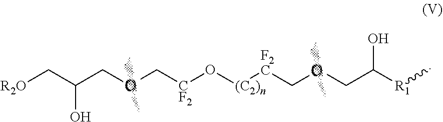

NMR (Nuclear Magnetic Resonance) measurements were performed on the lubricant after 30 minutes of normal HAMR operation. Fragments were detected in both tested and non-tested samples. An elevated abundance (e.g., >4×) of fragments were observed in tested disks as compared to non-tested samples. Fragments were not observed in neat lubricant, or were present in only trace amounts. Similar breakage was observed for a multivalent lubricant, as can be seen in formulas VI, VII and VIII:

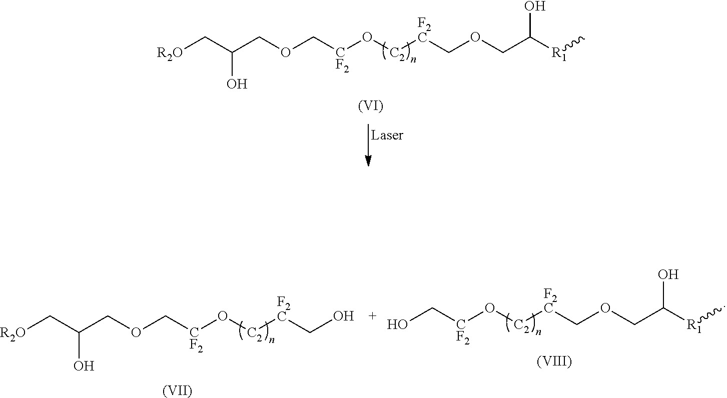

The relative abundance of the fragments is set forth in Table 3:

TABLE 3
Relative Abundance of Fragments VII and VIII.

| Formula VII | Relative | Formula VIII | Relative |
|---|---|---|---|
| Molecular Weight | Abundance | Molecular Weight | Abundance |
| M1 | 2.20 | M2 | 2.23 |
| M1 + 115.99 | 2.03 | M2 + 115.99 | 2.13 |
| M1 + 231.98 | 2.17 | M2 + 231.98 | 2.06 |
| M1 + 347.97 | 2.53 | M2 + 347.97 | 2.36 |

The results in Table 3 were obtained by LC-QTOF (Liquid Chromatography-Quadrapole Time of Flight Mass Spectroscopy). The relative abundance of the fragments of formula (VII) and formula (VIII) was compared to the undegraded neat material of formula (VI).

The tendency for fragmentation of the neat lubricant by exposure to HAMR operating conditions may be minimized by reducing the proportion of the weak ether bonds using epoxide chemistry. Various types of epoxide reactions in accordance with the disclosure are set forth in Table 4.

TABLE 4
Epoxide Reactions of the Disclosure.

| Type | Reaction | | Comments |
|---|---|---|---|
| Standard | 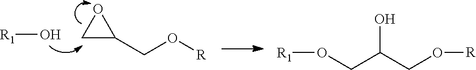 | (IX) | Two weak ether linkages, secondary- alcohol susceptible to |
| | | | oxidation (to |
| | | | ketone and |
| | | | further). |
| Tertiary alcohol | 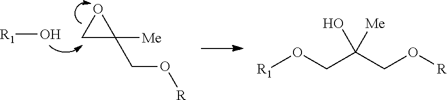 | (X) | Two weak ether linkages, tertiary- alcohol for difficult oxidation without breaking C-C bonds. |
| Styrene oxide and derivative | 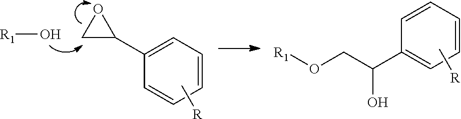 | (XI) | One weak ether linkage, secondary- alcohol susceptible to oxidation (to ketone and further). |
| Combination | 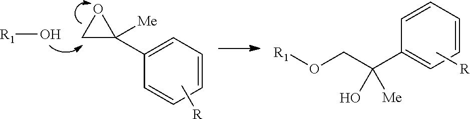 | (XII) | One weak ether linkage, tertiary- alcohol for difficult oxidation without breaking C-C bonds. |

Additional reactions can be made based upon diepoxys:

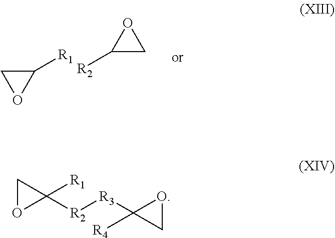

The epoxide based lubricant linkage chemistry in accordance with the disclosure may provide fewer weak ether bonds and/or substitutions near the ether bond that make bond breakage less likely. The epoxide chemistry of the disclosure provide lubricant structures such as, for example, in formula (Ia):

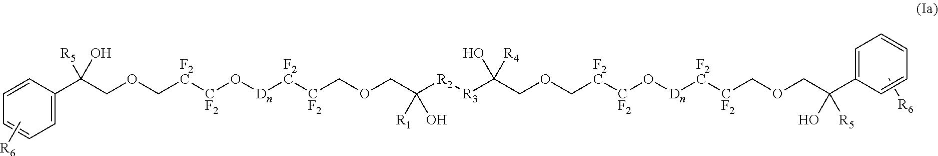

where R₁, R₂, R₃, R₄, R₅ and R₆ independently comprise single or branched non-fluorinated or fluorinated C₁-C₁₀ alkyl, C₁-C₁₀ alkoxy, benzene, naphthalene, anthracene, phenanthrene, dibenz[a,h]anthracene, pyrene or benzopyrene. D₁ is a perfluoroether group, e.g., —CF₂CF₂O—, —CF₂CF₂CF₂O—, etc. (or —(CF₂)ₘO— with m being 2 to 10) and n is from 2 to 50. More backbone repeating units can be included, such as C1/C2, KRYTOX (perfluoropolyether), etc. In formula (Ia), the end groups can be a substituted aromatic moiety such as anisole. However having a substituted aromatic moiety end group is option in embodiments according to the disclosure.

### Synthesis

Epoxide chemistry achieves the lubricants of the disclosure. A synthetic pathway for formula (Ie) starting from a diepoxy linked by two R components is as follows:

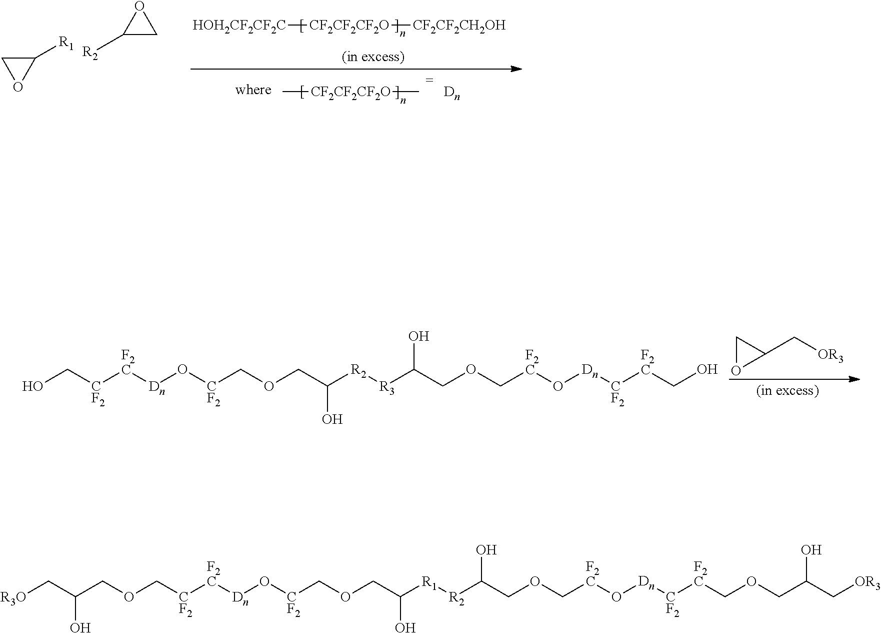

with R₁ to R₃ and Dₙ being defined above.

A modified synthetic route to formula (Ia)) starting from a diepoxy linked by four R components according to the disclosure can be as follows:

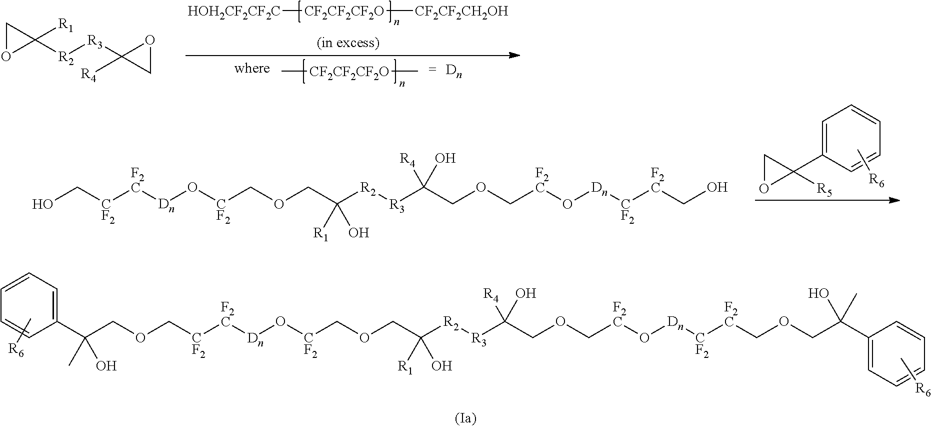

with R₁ to R₆ and Dₙ being defined above.

Among the advantages of the present disclosure is that the lubricants can be readily synthesized using commercially available reagents. A typical reaction is as follows:

### Reaction 1

Polyfluoro compounds having hydroxyl at both ends can react with glycidol in a solvent (e.g., t-butanol) in the presence of catalyst (potassium t-butoxide) at a temperature range of 40-80° C. (e.g., where 65° C. may be preferred). After 24 hours, the reaction mixture can be neutralized by acid, including 1 M HCl (1 molar hydrochloric acid), washed with 10% isopropanol in water and dried by rotary evaporation. The mixture can be separated by vacuum distillation, column chromatography or supercritical fluid extraction (SFE) using carbon dioxide.

### Divalent Linking Segment

Formula I has divalent linking segments R₂ and R₃. Formula (Ia) has divalent linking segments R₁ and R₂.

In one aspect of the disclosure each divalent linking segment independently can have the formula R_{L}, where R_{L} is CₙMₙ₊₂, where M is H or F, and n is from 1 to 10. In another aspect, the divalent linking segment can include anchoring functional groups, for example in Formula (XV) or (XVI), where the carbon atoms are non-fluorinated or fluorinated, as follows:

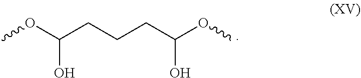

An aromatic moiety can be incorporated into linking segment, for example in Formula (XVI):

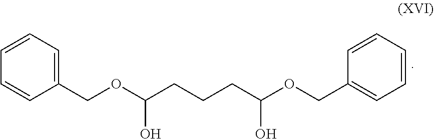 [SMILES: OC(CCCC(O)OCc1ccccc1)OCc1ccccc1]

The general formula (XVI) optionally contains no fluorine. The benzene rings have a higher rotational energy barrier than —CH₂— and thus add stiffness and increased temperature resistance to the molecule. The benzene ring can be substituted with any moiety that has a higher rotational energy barrier than —CH₂— and can even be a fluorinated species. In a related aspect, at least one aromatic moiety present on the linking segment Re may not be benzene, but may be may be an aromatic functional group including an aromatic C₅-C₅₀ radical.

In another aspect, the linking segment includes or is of general formula (XVII):

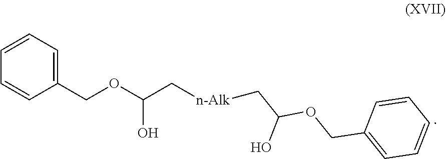

In general formula (XVII), n is from 1 to 50. The general formula (XVII) optionally contains no fluorine. The benzene rings have a higher rotational energy barrier than —CH₂— and thus add stiffness and increased temperature resistance to the molecule. The benzene ring can be substituted with any moiety that has a higher rotational energy barrier than —CH₂— and can even be a fluorinated species. In a related aspect, at least one aromatic moiety present on the linking segment Re may not be benzene, but may be may be an aromatic functional group including an aromatic C₅-C₅₀ radical.

In another aspect, the linking segment includes or is of general formula (XVIIa):

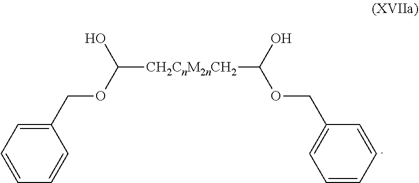

In general formula (XVIIa), Q_{L}, if present, is CₙMₙ₊₂, where M is H or F, and n is from 1 to 50.

### Chain Segment (Dₙ)

The chain segment Dₙ (e.g., of Formula I) may be defined as —((CF₂)ₘO)ₙ— or —((CH₂)ₘO)ₙ—.

The chain segment may also include a fluoroalkyl, fluoroalkenyl, perfluoroalkyl, or perfluoroalkyl ether moiety. In one aspect, each chain segment present in the lubricant may comprise or has the formula:

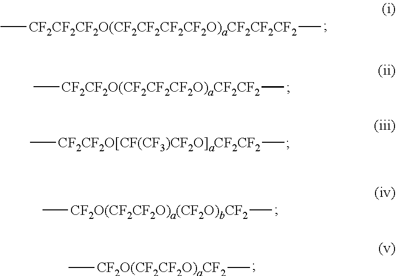

or a combination thereof, wherein each a is, independently from 1 to 100, or from 1 to 20, or from 1 to 10, or from 1 to 5, and wherein each b, when present, is independently from 1 to 100, or from 1 to 20, or from 1 to 10, or from 1 to 5.

### Anchoring Functional Groups

The lubricants of the disclosure contain anchoring functional groups, which are typically —OH. However, the anchoring functional groups are not restricted to —OH but may be an anchoring functional group attachable to and/or engageable with a protective overcoat of a magnetic recording medium, comprising: a B, Si, pnictogen, chalcogen, or halogen, —OR*, —NR*₂, —NR*—CO—R*, —OR*, —O—CO—R*, —CO—O—R*, —SeR*, —TeR*, —PR*₂, other P(III) groups including —PO—(OR*)₂ and —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, or a saturated, unsaturated, aromatic, polycyclic aromatic, heteroaromatic, alicyclic, and/or a heterocyclic C₁-C₅₀ radical, and two or more R* may join together to form a ring structure. In one aspect, each end segment Re¹ and Re² may independently include at least one R¹ which may be a cyclic functional group which may include an alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof, which may be further substituted with a functional group as disclosed herein. Anchoring functional groups can also include OH, —NH₂, —NH—CO—H, —OH, —O—CO—H, —CO—O—H, —SeH, —TeH, —PH₂, —PO—(OH)₂, —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof, wherein q is 1 to 10.

In one or more aspects, the lubricants are stable above about 250° C., or above about 300° C., or above about 325° C., or above about 350° C., or above about 375° C., and less than or equal to about 450° C., or 425° C. when determined in air, nitrogen, helium, or 90 vol % helium/10 vol % oxygen.

In one or more aspects, the lubricant has a weight average molecular weight of greater than or equal to about 0.5 kiloDalton (kDa), or from about 1 to about 20 kDa, or from about 2 to about 10 kDa, or from about 3 to about 7 kDa, or from about 1 to about 5 kDa, or 2 to about 4 kDa.

In one or more aspects, the lubricant has a weight average molecular weight of greater than or equal to about 500 grams per mole (g/mol), or from about 1,000 to about 20,000 g/mol, or from about 2,000 to about 10,000 g/mol, or from about 3,000 to about 7,000 g/mol, or from about 1,000 to about 5,000 g/mol, or 2,000 to about 4,000 g/mol.

In one or more aspects, the lubricants are essentially pure compounds, having a polydispersity, defined as the number average molecular weight Mn divided by the weight average molecular weight Mw (Mw/Mn) from about 1 to 2, or from about 1 to about 1.5, or from about 1 to about 1.1, or from about 1 to about 1.05.

In one or more aspects, the average thickness of the lubricant layer of the magnetic recording medium is less than about 10 nanometers (nm), or less than about 5 nm, or less than or equal to about 1 nm. In some aspects, the lubricant of the magnetic recording medium has an average thickness from about 0.1 nm to about 10 nm, or from about 0.1 nm to about 1 nm.

In one or more aspects of the magnetic recording medium, the lubricant may have a bonding percentage of at least about 30%, or at least about 50%, or at least about 70%, or at least about 80%, or at least about 90%, and less than or equal to about 99%, or less than or equal to about 95%, corresponding to a post-stripping bonding level of the lubricant to the total area of an upper surface of the protective overcoat.

### Media Fabrication

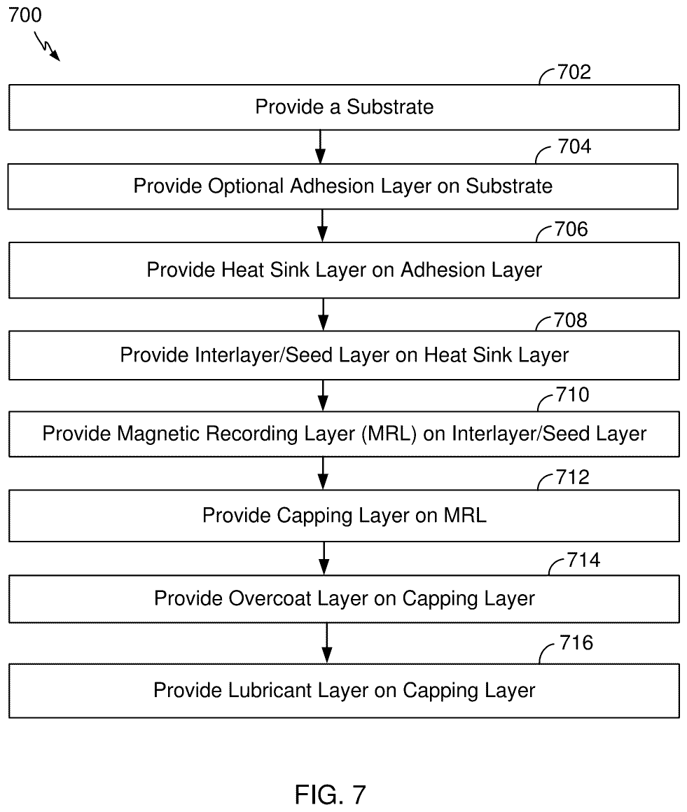

FIG. 7 is a flowchart of an exemplary process 700 for fabricating a HAMR medium that includes a lubricant in accordance with an aspect of the disclosure. In one aspect, the process 700 can be used to fabricate the HAMR media described above, including medium 200 shown in FIG. 2.

At block 702, the process provides a substrate (e.g., substrate 202). At block 704, the process provides an optional adhesion layer (e.g., adhesion layer 204). At block 706, the process provides a heat sink layer (e.g., heat sink layer 206). In one aspect, at block 708, the process may additionally provide an interlayer/seed layer (e.g., interlayer 208). At block 710, the process provides a magnetic recording layer (MRL) (e.g., MRL 210). At block 712, the process provides a capping layer (e.g., capping layer 212).

At block 714, the process provides an overcoat layer (e.g., overcoat layer 214). At block 716, the process provides a lubricant layer (e.g., lubricant layer 218).

It is important to note that in alternative approaches, the lubricant layer formed above the protective overcoat may include any of the multidentate fluoroalkyl, fluoroalkenyl, perfluoroalkyl, or perfluoropolyether boundary lubricants described herein, singly and/or in any combination.

In various aspects, the lubricant layer can be formed on the magnetic recording medium, specifically on the protective overcoat, via a dip coating method. For instance, in one aspect the magnetic recording medium may be dipped into a lubricant bath including the multidentate perfluoropolyether boundary lubricant according to one or more aspects of the disclosure and a fluorocarbon solvent such as HFE7100 (methoxy-nonafluorobutane) or VERTREL-XF (hydrofluorocarbon fluid). After a predetermined amount of time, the magnetic recording medium may be pulled out from the lubricant bath at a controlled rate. The solvent may then evaporate, leaving behind a lubricant layer comprising the multidentate perfluoropolyether boundary lubricant. The bonding percentage is quantified by stripping the lubricated magnetic recording medium with the solvents used in the lubricant bath at various post-lube time periods.

The thickness of the lubricant layer may be tuned by controlling the submergence duration of the magnetic recording medium in the lubricant bath, the rate at which the magnetic recording medium is removed from the coating solution, and/or the concentration of the boundary lubricant (e.g. the lubricant according to one or more aspects of the disclosure) in the lubricant bath.

In one or more aspects, the concentration of lubricant in the lubricant bath may be in a range from about 0.001 g/L to about 1 g/L. In yet other aspects, the concentration of the lubricant in the lubricant bath may be selected so as to achieve a resulting lubricant layer with a thickness in a range of less than or equal to about 10 nanometers (nm), or less than or equal to about 5 nm, or less than or equal to about 1 nm or from 0.1 nm to less than about 1 nm.

Likewise, the formation of the lubricant layer on the surface of the magnetic recording medium, specifically on the surface of the protective overcoat, is not limited to dip coating, but may also involve spin coating, spray coating, a vapor deposition, combinations thereof, or any other suitable coating process as would be understood by one having skill in the art upon reading the present disclosure.

It should be noted that methodology presented herein for at least some of the various aspects may be implemented, in whole or in part, in computer hardware, by hand, using specialty equipment, etc. and combinations thereof.

Moreover, any of the structures and/or steps may be implemented using known materials and/or techniques, as would become apparent to one skilled in the art upon reading the present disclosure.

In some aspects, the processes herein can perform the sequence of actions as described above for media fabrication in a different order. In other aspects, the processes can skip one or more of the actions. In still other aspects, one or more of the actions are performed simultaneously. In some aspects, additional actions can be performed. For example, in one aspect, the process may include any additional actions needed to fabricate the magnetic recording layer structure.

In some aspects, the forming or deposition of such layers can be performed using a variety of deposition sub-processes, including, but not limited to physical vapor deposition (PVD), direct current (DC) sputter deposition, ion beam deposition, radio frequency sputter deposition, or chemical vapor deposition (CVD), including plasma enhanced chemical vapor deposition (PECVD), low pressure chemical vapor deposition (LPCVD) and atomic layer chemical vapor deposition (ALCVD). In other embodiments, other suitable deposition techniques known in the art may also be used.

The terms “on,” “above,” “below,” and “between” as used herein refer to a relative position of one layer with respect to other layers. As such, one layer deposited or disposed on/above or below another layer may be directly in contact with the other layer or may have one or more intervening layers. Moreover, one layer deposited or disposed between layers may be directly in contact with the layers or may have one or more intervening layers.

Accordingly, the lubricants according to aspects of this disclosure demonstrate improved thermal stability/oxidation resistance, improved contamination robustness at sub-nanometer level, low profile for higher ADC with improved writability/readability, reasonable head wear and flyability performances, an improved bonding ratio, and improved processability/yields with an increased uniformity. The lubricants according to aspects of this disclosure are suitable for use in high-temperature applications while maintaining or improving mechanical interface integration robustness, reliability, and magnetic spacing.

As has been shown, lubricant oxidation is one of the major factors for lubricant loss under thermal treatments (laser or heat). The modified lubricant provides higher oxidation resistance, thus a higher thermal decomposition threshold. New linkage chemistries utilize the same epoxide ring opening reaction, requiring minimum modification on lubricant structures/functionalities and reaction conditions.

The above description is made for the purpose of illustrating the general principles of the present disclosure and is not meant to limit the inventive concepts claimed herein. Further, particular features described herein can be used in combination with other described features in each of the various possible combinations and permutations.

It should be noted that in the development of any such actual aspect, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the device, system and/or method used/disclosed herein can also comprise some components other than those cited.

Unless otherwise specifically defined herein, all terms are to be given their broadest possible interpretation including meanings implied from the specification as well as meanings understood by those skilled in the art and/or as defined in dictionaries, treatises, and the like.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 20 angstroms (Å) refers to a thickness of 20 Å+/−2 Å, e.g., from 18 Å to 22 Å in this example.

In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.” The term “and/or” refers to both the inclusive “and” case and the exclusive “or” case, and such term is used herein for brevity. For example, a composition comprising “A and/or B” may comprise A alone, B alone, or both A and B.

Various components described in this specification may be described as “including” or made of certain materials or compositions of materials. In one aspect, this can mean that the component consists of the particular material(s). In another aspect, this can mean that the component comprises the particular material(s).

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. It is further noted that the term “over” as used in the present application in the context of one component located over another component, may be used to mean a component that is directly on another component and/or in another component (e.g., directly on a surface of a component or embedded in a component). Thus, for example, a first component that is over the second component may mean that (1) the first component is over the second component, but not directly touching the second component, (2) the first component is directly on (e.g., directly on a surface of) the second component, and/or (3) the first component is in (e.g., embedded in) the second component. The term “about ‘value X’”, or “approximately value X,” as used in the disclosure shall mean within 10 percent of the ‘value X’. For example, a value of about 1 or approximately 1 would mean a value in a range of 0.9-1.1. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range. In the disclosure various values (e.g., value X) may be specified, described and/or claimed. In one embodiment, it should be understood that the value X may be exactly equal to X. In one embodiment, it should be understood that the value X may be “about X,” with the meaning noted above.

While various aspects have been described above, it should be understood that they have been presented by way of example only, and not limitation. Thus, the breadth and scope of an aspect of the present invention should not be limited by any of the above-described exemplary aspects, but should be defined only in accordance with the following claims and their equivalents.

What is claimed is:

1. An epoxide based lubricant according to one of general formulas (Ia) to (Id): 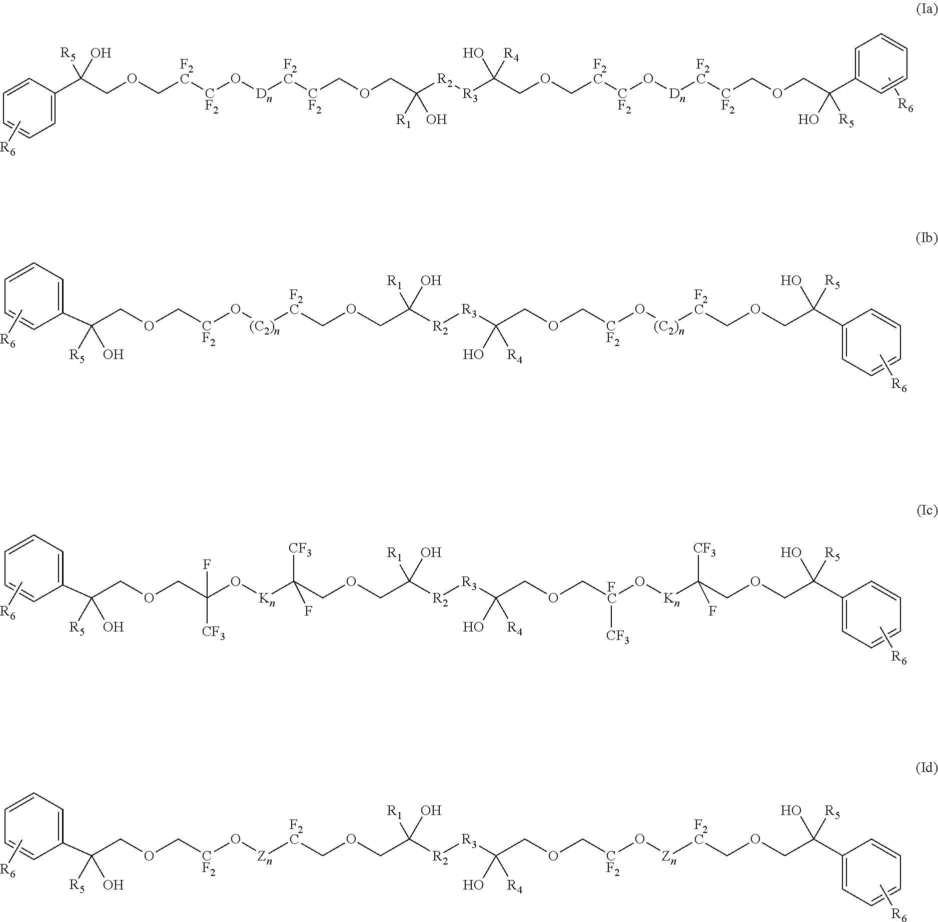
where Dₙ is —(CF₂CF₂CF₂O)ₙ—,
(C₂)ₙ is —(CF₂CF₂O)ₙ—,
Kₙ is —(CF₂CF(CF₃)O)ₙ—,
Zₙ is —(CF₂CF₂O)ₓ(CF₂O)_{y},
R₁, R₂, R₃, R₄, R₅ and R₆ independently comprise single or branched non-fluorinated or fluorinated C₁-C₁₀ alkyl, C₁-C₁₀ alkoxy, benzene, naphthalene, anthracene, phenanthrene, dibenz[a,h]anthracene, pyrene or benzopyrene, with n, x and y each independently being from 2 to 50.

2. The lubricant of claim 1, wherein R₁, R₂, R₃, R₄, R₅ and R₆ independently comprise single or branched non-fluorinated or fluorinated C₁-C₁₀ alkyl.

3. The lubricant of claim 1, wherein R₁, R₂, R₃, R₄, R₅ and R₆ each comprise methyl.

4. The lubricant of claim 1, wherein R₁, R₂, R₃, R₄, R₅ and R₆ each comprise benzyl.

5. The lubricant of claim 1, wherein R₂ and R₃ comprise a divalent linking segment.

6. A magnetic recording medium, comprising:
a magnetic recording layer on a substrate;
a protective overcoat on the magnetic recording layer; and
a lubricant layer comprising the lubricant according to claim 1 on the protective overcoat.

7. A data storage system, comprising:
at least one magnetic head;
a magnetic recording medium including the lubricant of claim 1;
a drive mechanism for positioning the at least one magnetic head over the magnetic recording medium; and
a controller electrically coupled to the at least one magnetic head for controlling operation of the at least one magnetic head.

8. A data storage system, comprising:
a slider comprising at least one magnetic head and an air bearing surface (ABS), wherein a lubricant according to claim 1 is disposed on the ABS; and
a magnetic recording medium including a magnetic recording layer;
wherein the slider is configured to write information to the magnetic recording layer using heat assisted magnetic recording (HAMR), microwave assisted magnetic recording (MAMR), perpendicular magnetic recording (PMR), energy-assisted perpendicular magnetic recording (ePMR) or shingled magnetic recording (SMR).

9. A method of synthesizing a lubricant of the formula (Ia) of claim 1, comprising:

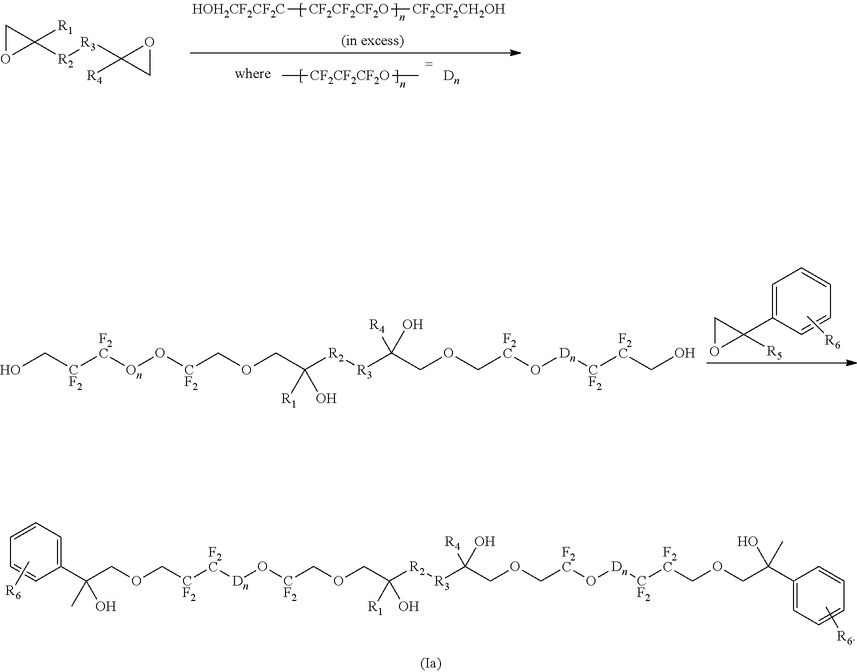

10. The method of claim 9, wherein each reaction step is performed in t-butanol in the presence of potassium t-butoxide catalyst at 40° C. to 80° C. to yield a reaction mixture, and the reaction mixture is neutralized with acid, washed with alcohol, and the product of formula (Ia) of claim 9 is separated by vacuum distillation, column chromatography or supercritical fluid extraction.

11. An epoxide based lubricant according to one of general formulas (Ie) to (Ih): 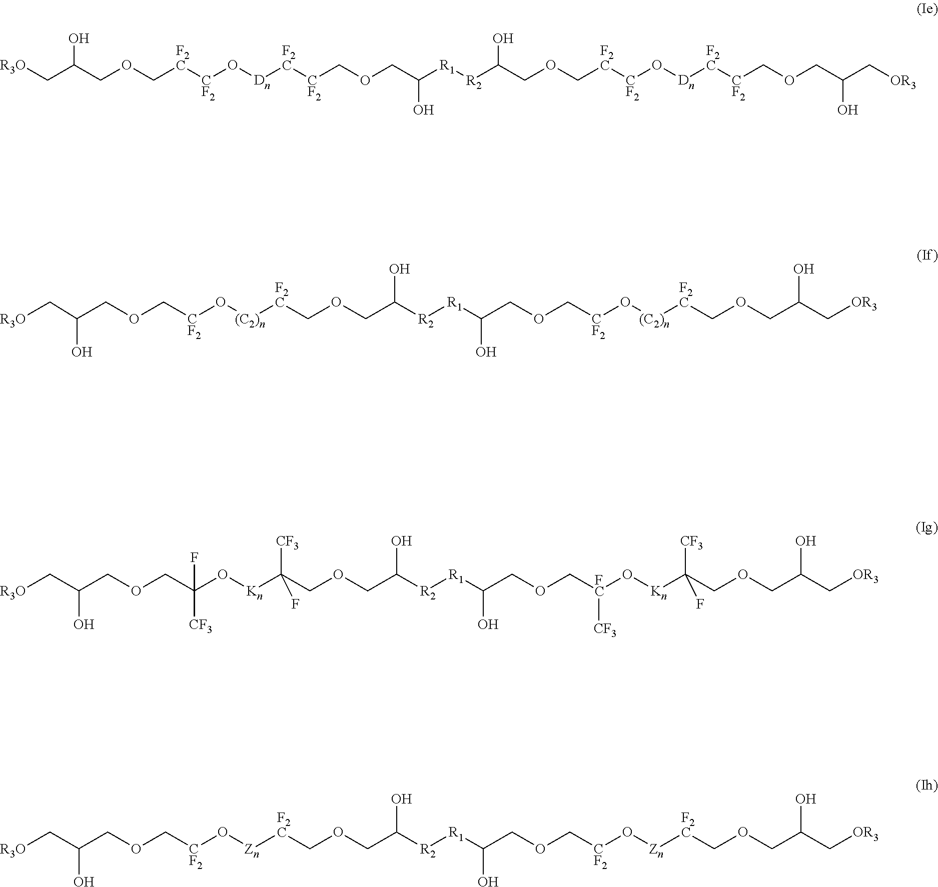
where Dₙ is —(CF₂CF₂CF₂O)ₙ—,
(C₂)ₙ is —(CF₂CF₂O)ₙ—,
Kₙ is —(CF₂CF(CF₃)O)ₙ—,
Zₙ is —(CF₂CF₂O)ₓ(CF₂O)_{y},
R₁, R₂, R₃, R₄, R₅ and R₆ independently comprise single or branched non-fluorinated or fluorinated C₁-C₁₀ alkyl, C₁-C₁₀ alkoxy, benzene, naphthalene, anthracene, phenanthrene, dibenz[a,h]anthracene, pyrene or benzopyrene, with n, x and y each independently being from 2 to 50.

12. A method of synthesizing a lubricant of the formula (Ie) of claim 11, comprising:

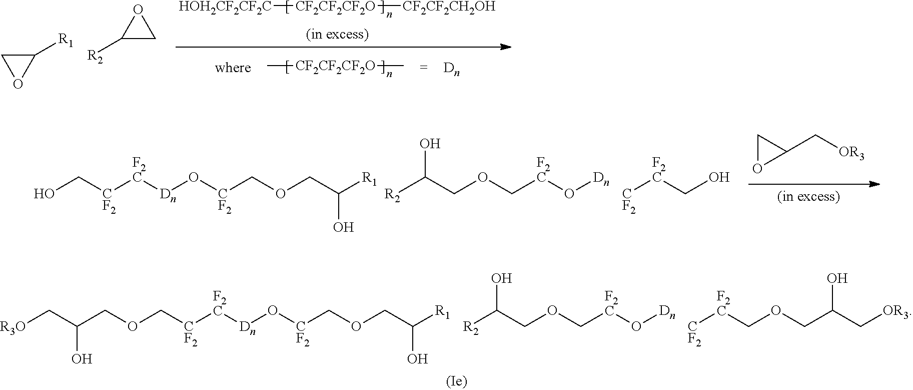

13. The method of claim 12, wherein each reaction step is performed in t-butanol in the presence of potassium t-butoxide catalyst at 40° C. to 80° C. to yield a reaction mixture.

14. The method of claim 12, wherein each reaction step is performed in t-butanol in the presence of potassium t-butoxide catalyst at 40° C. to 80° C. to yield a reaction mixture, and the reaction mixture is neutralized with acid, washed with alcohol, and the product of formula (Ia) is separated by vacuum distillation, column chromatography or supercritical fluid extraction.

15. A magnetic recording medium, comprising:
a magnetic recording layer on a substrate;
a protective overcoat on the magnetic recording layer; and
a lubricant layer comprising the lubricant according to claim 11 on the protective overcoat.

16. A data storage system, comprising:
at least one magnetic head;
a magnetic recording medium including the lubricant according to claim 11;
a drive mechanism for positioning the at least one magnetic head over the magnetic recording medium; and
a controller electrically coupled to the at least one magnetic head for controlling operation of the at least one magnetic head.

17. A data storage system, comprising:
a slider comprising at least one magnetic head and an air bearing surface (ABS), wherein the lubricant according to claim 11 is disposed on the ABS; and
a magnetic recording medium including a magnetic recording layer;
wherein the slider is configured to write information to the magnetic recording layer using heat assisted magnetic recording (HAMR).

18. An epoxide based lubricant according to general formula (Ia): 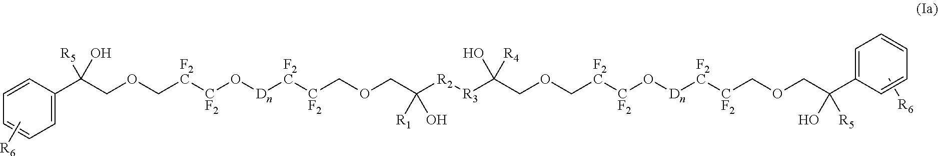
where Dₙ is —(CF₂CF₂CF₂O)ₙ—,
R₁, R₂, R₃, R₄, R₅ and R₆ independently comprise single or branched non-fluorinated or fluorinated C₁-C₁₀ alkyl, C₁-C₁₀ alkoxy, benzene, naphthalene, anthracene, phenanthrene, dibenz[a,h]anthracene, pyrene or benzopyrene, with n being from 2 to 50.

19. The lubricant of claim 18, wherein R₁, R₂, R₃, R₄, R₅ and R₆ independently comprise single or branched non-fluorinated or fluorinated C₁-C₁₀ alkyl, or R₁, R₂, R₃, R₄, R₅ and R₆ each comprise methyl or benzyl.

20. The lubricant of claim 18, wherein R₂ and R₃ comprise a divalent linking segment.
